(19) United States
(12) Patent Application Publication
(10) Pub. No.: US 2022/0197082 A1
(43) Pub. Date: Jun. 23, 2022

(54) LIQUID CRYSTAL DISPLAY DEVICE AND METHOD FOR FABRICATING SAME

(71) Applicant: HUIZHOU CHINA STAR OPTOELECTRONICS TECHNOLOGY CO.,, Huizhou, Guangdong (CN)

(72) Inventor: Bo HAI, Huizhou, Guangdong (CN)

(21) Appl. No.: 17/054,828

(22) PCT Filed: Oct. 22, 2020
(86) PCT No.: PCT/CN2020/122934

§ 371 Date: Nov. 12, 2020

(51) Int. Cl. G02F 1/1335; G02B 1/11

(52) U.S. Cl. CPC G02F 1/133531; G02F 1/133514; G02B 1/11

(57) ABSTRACT

A liquid crystal display device and a method for fabricating the same are provided. The method includes: providing a liquid crystal display panel, wherein the liquid crystal display panel includes a light-incident surface and a light-emitting surface on opposite sides thereof; disposing a first polarizer on the light-incident surface or the light-emitting surface of the liquid crystal display panel; and directly forming a first anti-reflection film on a surface of the first polarizer away from the liquid crystal display panel.

### FIELD OF INVENTION

The present disclosure relates to the technical field of display, and particularly to a liquid crystal display device and a method for fabricating the same.

### BACKGROUND

For liquid crystal display devices, the greater the transmittance, the greater the brightness. Brightness of liquid crystal display devices directly affects people's perception of image quality. The most important factor determining transmittance is an aperture ratio of a liquid crystal display panel in a liquid crystal display device. Currently, an aperture ratio is mainly increased by improving a structure and a manufacturing process of a liquid crystal display panel.

However, nowadays, a demand for high resolution of liquid crystal display panels is increasing. The greater the resolution, the less the aperture ratio. Therefore, under the demand for high resolution, it is difficult to increase transmittance by increasing an aperture ratio. In addition, in the current technology, it is also difficult to increase transmittance by reducing a light absorption rate of each layer in a liquid crystal display panel. Furthermore, a current anti-reflection film is very thin, so it needs to be formed on a thicker base film first, and then coated with an adhesive layer, so that it can be attached to another component. Accordingly, if the anti-reflection film is applied to a liquid crystal display device, a thickness and process procedures of the liquid crystal display device will increase. In view of this, how to improve a transmittance of a liquid crystal display device without changing its manufacturing process, structure, and thickness is an urgent problem to be solved in the industry.

### SUMMARY OF DISCLOSURE

A purpose of the present invention is to improve a transmittance of a liquid crystal display device without changing its manufacturing process, structure, and thickness.

To achieve the above purpose, the present disclosure provides a method for fabricating a liquid crystal display device. The method comprises: providing a liquid crystal display panel, wherein the liquid crystal display panel comprises a light-incident surface and a light-emitting surface on opposite sides thereof; disposing a first polarizer on the light-incident surface or the light-emitting surface of the liquid crystal display panel; and directly forming a first anti-reflection film on a surface of the first polarizer away from the liquid crystal display panel.

In an embodiment, the method further comprises: disposing a second polarizer on a surface of the liquid crystal display panel away from the first polarizer; and directly forming a second anti-reflection film on a surface of the second polarizer away from the liquid crystal display panel.

In an embodiment, the first polarizer is disposed on the light-incident surface of the liquid crystal display panel. The first polarizer comprises a protective layer disposed on a side of the first polarizer furthest away from the liquid crystal display panel to prevent moisture from entering the first polarizer. The first anti-reflection film is directly formed on a surface of the protective layer of the first polarizer away from the liquid crystal display panel.

In this embodiment, the method further comprises: disposing a second polarizer on the light-emitting surface of the liquid crystal display panel, wherein the second polarizer comprises a hardened layer disposed on a side of the second polarizer furthest away from the liquid crystal display panel; and directly forming a second anti-reflection film on a surface of the hardened layer of the second polarizer away from the liquid crystal display panel.

In this embodiment, the method further comprises: disposing a second polarizer on the light-emitting surface of the liquid crystal display panel, wherein the second polarizer comprises an anti-glare coating disposed on a side of the first polarizer furthest away from the liquid crystal display panel; and directly forming a second anti-reflection film on a surface of the anti-glare coating of the second polarizer away from the liquid crystal display panel.

In an embodiment, the first polarizer comprises a hardened layer disposed on a side of the first polarizer furthest away from the liquid crystal display panel to prevent the first polarizer from being scratched. The first anti-reflection film is directly formed on a surface of the hardened layer of the first polarizer away from the liquid crystal display panel.

In this embodiment, the method further comprises: disposing a second polarizer on the light-emitting surface of the liquid crystal display panel, wherein the second polarizer comprises a hardened layer disposed on a side of the second polarizer furthest away from the liquid crystal display panel to prevent the second polarizer from being scratched; and directly forming a second anti-reflection film on a surface of the hardened layer of the second polarizer away from the liquid crystal display panel.

In this embodiment, the method further comprises: disposing a second polarizer on the light-emitting surface of the liquid crystal display panel, wherein the second polarizer comprises an anti-glare coating disposed on a side of the first polarizer furthest away from the liquid crystal display panel; and directly forming a second anti-reflection film on a surface of the anti-glare coating of the second polarizer away from the liquid crystal display panel.

In an embodiment, the first polarizer is disposed on the light-emitting surface of the liquid crystal display panel. The first polarizer comprises an anti-glare coating disposed on a side of the first polarizer furthest away from the liquid crystal display panel. The first anti-reflection film is directly formed on a surface of the anti-glare coating of the first polarizer away from the liquid crystal display panel.

The present disclosure further provides a liquid crystal display device comprising a liquid crystal display panel, a first polarizer, and a first anti-reflection film. The liquid crystal display panel comprises a light-incident surface and a light-emitting surface on opposite sides thereof. The first polarizer is disposed on the light-incident surface or the light-emitting surface of the liquid crystal display panel. The first anti-reflection film is directly formed on a surface of the first polarizer away from the liquid crystal display panel.

In an embodiment, the liquid crystal display device further comprises a second polarizer and a second anti-reflection film. The second polarizer is disposed on a surface of the liquid crystal display panel away from the first polarizer. The second anti-reflection film is directly formed on a surface of the second polarizer away from the liquid crystal display panel.

In an embodiment, the first polarizer is disposed on the light-incident surface of the liquid crystal display panel. The first polarizer comprises a protective layer disposed on a side of the first polarizer furthest away from the liquid crystal display panel to prevent moisture from entering the first polarizer. The first anti-reflection film is directly formed on a surface of the protective layer of the first polarizer away from the liquid crystal display panel.

In this embodiment, the liquid crystal display device further comprises a second polarizer and a second anti-reflection film. The second polarizer is disposed on the light-emitting surface of the liquid crystal display panel and comprises a hardened layer. The hardened layer is disposed on a side of the second polarizer furthest away from the liquid crystal display panel to prevent the second polarizer from being scratched. The second anti-reflection film is directly formed on a surface of the hardened layer of the second polarizer away from the liquid crystal display panel.

In this embodiment, the liquid crystal display device further comprises a second polarizer and a second anti-reflection film. The second polarizer is disposed on the light-emitting surface of the liquid crystal display panel and comprises an anti-glare coating. The anti-glare coating is disposed on a side of the second polarizer furthest away from the liquid crystal display panel. The second anti-reflection film is directly formed on a surface of the anti-glare coating of the second polarizer away from the liquid crystal display panel.

In an embodiment, the first polarizer comprises a hardened layer disposed on a side of the first polarizer furthest away from the liquid crystal display panel to prevent the first polarizer from being scratched. The first anti-reflection film is directly formed on a surface of the hardened layer of the first polarizer away from the liquid crystal display panel.

In this embodiment, the liquid crystal display device further comprises a second polarizer and a second anti-reflection film. The second polarizer is disposed on the light-emitting surface of the liquid crystal display panel and comprises a hardened layer. The hardened layer is disposed on a side of the second polarizer furthest away from the liquid crystal display panel to prevent the second polarizer from being scratched. The second anti-reflection film is directly formed on a surface of the hardened layer of the second polarizer away from the liquid crystal display panel.

In this embodiment, the liquid crystal display device further comprises a second polarizer and a second anti-reflection film. The second polarizer is disposed on the light-emitting surface of the liquid crystal display panel and comprises an anti-glare coating. The anti-glare coating is disposed on a side of the second polarizer furthest away from the liquid crystal display panel. The second anti-reflection film is directly formed on a surface of the anti-glare coating of the second polarizer away from the liquid crystal display panel.

In an embodiment, the first polarizer is disposed on the light-emitting surface of the liquid crystal display panel. The first polarizer comprises an anti-glare coating disposed on a side of the first polarizer furthest away from the liquid crystal display panel. The first anti-reflection film is directly formed on a surface of the anti-glare coating of the first polarizer away from the liquid crystal display panel.

In the liquid crystal display device and the method for fabricating the same provided by the present disclosure, the first anti-reflection film is directly formed on the first polarizer, and/or the second anti-reflection film is directly formed on the second polarizer. In this way, without changing a manufacturing process and a structure of the liquid crystal panel and an overall thickness of the liquid crystal display device, a reflectivity of the liquid crystal display device can be reduced, thereby improving a transmittance of the liquid crystal display device.

### BRIEF DESCRIPTION OF DRAWINGS

In order to more clearly illustrate technical solutions in embodiments of the present disclosure or the prior art, a brief description of accompanying drawings used in the embodiments or the prior art will be given below. Obviously, the accompanying drawings in the following description are merely some embodiments of the present disclosure. For those skilled in the art, other drawings may be obtained from these accompanying drawings without creative labor.

FIG. 1 is a schematic diagram of a liquid crystal display device of the present invention.

FIG. 2 is a schematic diagram of a liquid crystal display device according to a first embodiment of the present invention.

FIG. 3 is a schematic diagram of a liquid crystal display device according to a second embodiment of the present invention.

FIG. 4 is a schematic diagram of a liquid crystal display device according to a third embodiment of the present invention.

FIG. 5 is a schematic diagram of a liquid crystal display device according to a fourth embodiment of the present invention.

### DETAILED DESCRIPTION

Technical solutions in embodiments of the present disclosure will be clearly and completely described below in conjunction with accompanying drawings. The described embodiments are merely a part of the embodiments of the present disclosure and not all embodiments. All other embodiments obtained by those skilled in the art based on the embodiments of the present disclosure without creative labor are within the claimed scope of the present disclosure.

In a description of the present disclosure, orientation or positional relationship indicated by terms, such as “above”, “below”, “top”, “bottom”, “left”, “right”, “inside”, “outside”, and “side”, is based on orientation or positional relationship shown in the accompanying drawings, and is merely for convenience and simplification of the description of the present disclosure. Furthermore, terms such as “first” and “second” are used merely for description, but shall not be construed as indicating or implying relative importance. Features defined with the terms, such as “first” and “second”, may explicitly or implicitly include one or more such features.

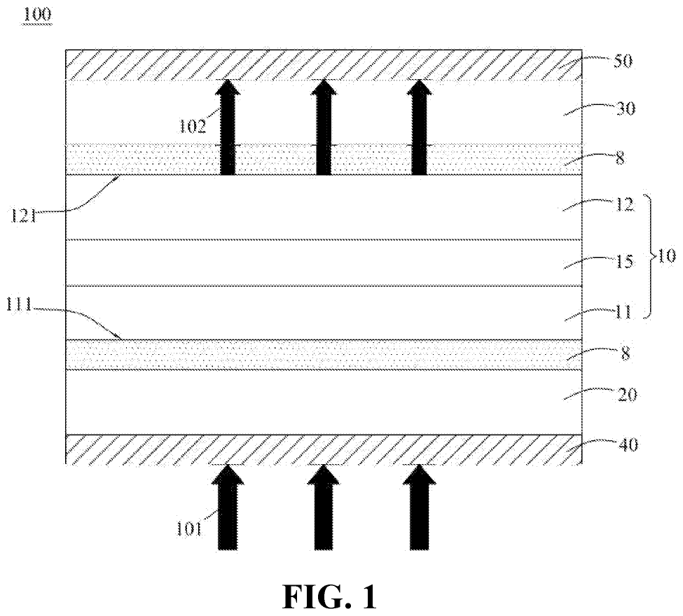

Please refer to FIG. 1, the present disclosure provides a method for fabricating a liquid crystal display device 100. The method comprises the following steps.

Step 1: providing a liquid crystal display panel 10. The liquid crystal display panel 10 comprises a light-incident surface 111 and a light-emitting surface 121 on opposite sides thereof. Specifically, the liquid crystal display panel 10 comprises an array substrate 11, a color filter substrate 12, and a liquid crystal layer 15. The array substrate 11 and the color filter substrate 12 are disposed oppositely. The liquid crystal layer 15 is disposed between the array substrate 11 and the color filter substrate 12. The light-incident surface 111 of the liquid crystal display panel 10 is a surface of the array substrate 11 away from the liquid crystal layer 15. The light-emitting surface 121 of the liquid crystal display panel 10 is a surface of the color filter substrate 12 away from the liquid crystal layer 15.

Step 2: disposing a first polarizer 20 on the light-incident surface 111 of the liquid crystal display panel 10, and/or disposing a second polarizer 30 on the light-emitting surface 121 of the liquid crystal display panel 10. In an embodiment, the liquid crystal display panel 10 may only be provided with the first polarizer 20 or the second polarizer 30.

Specifically, the disposing the first polarizer 20 on the light-incident surface 111 comprises: coating an adhesive on the first polarizer 20 or the light-incident surface 111 to form an adhesive layer 8, and attaching the first polarizer 20 to the light-incident surface 111 through the adhesive layer 8. The disposing the second polarizer 30 on the light-emitting surface 121 comprises: coating the adhesive on the second polarizer 30 or the light-emitting surface 121 to form another adhesive layer 8, and attaching the second polarizer 30 to the light-emitting surface 121 through the adhesive layer 8. The adhesive may be a pressure-sensitive adhesive (PSA). The pressure-sensitive adhesive may be a polypropylene-based adhesive, but is not limited thereto.

In an embodiment, positions of the first polarizer 20 and the second polarizer 30 can be interchanged. That is, Step 2 may also be: disposing a first polarizer 20 on the light-emitting surface 121 of the liquid crystal display panel 10, and/or disposing a second polarizer 30 on the light-incident surface 111 of the liquid crystal display panel 10.

Step 3: directly forming a first anti-reflection film 40 on a surface of the first polarizer 20 away from the liquid crystal display panel 10 when the light-incident surface 111 is provided with the first polarizer 20, and directly forming a second anti-reflection film 50 on a surface of the second polarizer 30 away from the liquid crystal display panel 10 when the light-emitting surface 121 is provided with the second polarizer 30. Specifically, the first anti-reflection film 40 and the second anti-reflection film 50 may be formed by depositing an anti-reflection material on the first polarizer 20 and the second polarizer 30 by vacuum evaporation or sputtering, but are not limited thereto. The anti-reflection material may be a material with a low refractive index and high strength, such as magnesium fluoride. The first anti-reflection film 40 and the second anti-reflection film 50 may be formed of a same material or different materials.

In order to achieve a purpose of anti-reflection, a first thickness of the first anti-reflection film 40 may be adjusted based on a first refractive index of the first anti-reflection film 40 and a spectrum of a first light 101 emitted by a backlight panel, so that destructive interference occurs between lights reflected by upper and lower interfaces of the first anti-reflection film 40.

In order to achieve a better anti-reflection effect, a preferred first thickness e₁ of the first anti-reflection film 40 may be calculated by the following formula (I).

$${e}_{1} = \frac{{λ}_{1}}{4 \times {n}_{1}} \qquad Formula ( I )$$

e₁ is the first thickness of the first anti-reflection film 40, λ₁ is a first wavelength of the first light 101, and n₁ is the first refractive index of the first anti-reflection film 40.

Generally, refractive indexes of glass substrates and polarizers are about 1.52, and a refractive index of air is 1. Therefore, the first refractive index of the first anti-reflection film 40 is preferably 1.23 to 1.38, but is not limited thereto. The first reflectivity may be adjusted by changing a material of the first anti-reflection film 40. The first wavelength may be a wavelength of the first light 101 that mainly provides brightness of the liquid crystal display device 10. That is, the anti-reflection is performed on a wavelength that the backlight panel mainly provides the brightness of the liquid crystal display device 10. Wavelengths of commonly used backlight panels that mainly provide the brightness of the liquid crystal display device 10 are 450 nm and 500 nm-630 nm. Therefore, the first wavelength of the first light 101 may be 450 nm or 500 nm-630 nm, but is not limited thereto. The first wavelength may be adjusted by changing a spectrum of the backlight panel. When the first refractive index is 1.23 to 1.38, and the wavelength of the first light 101 is 450 nm or 500 nm to 630 nm, the first thickness of the first anti-reflection film 40 is preferably 81.5 nm to 128 nm, but is not limited thereto.

For example, when the first wavelength λ₁ is 450 nm, if the first refractive index n₁ is set to 1.23, the first thickness e₁ is preferably 91.44 nm; and if the first refractive index n₁ is set to 1.38, the first thickness e₁ is preferably 81.5 nm. When the first wavelength λ₁ is 500 nm, if the first refractive index n₁ is set to 1.23, the first thickness e₁ is preferably 101.6 nm; and if the first refractive index n₁ is set to 1.38, the first thickness e₁ is preferably 90.6 nm. When the first wavelength λ₁ is 550 nm, if the first refractive index n₁ is set to 1.23, the first thickness e₁ is preferably 111.8 nm; and if the first refractive index n₁ is set to 1.38, the first thickness e₁ is preferably 99.7 nm. When the first wavelength κ₁ is 630 nm, if the first refractive index n₁ is set to 1.23, the first thickness e₁ is preferably 128 nm; and if the first refractive index n₁ is set to 1.38, the first thickness e₁ is preferably 114.2 nm.

Similarly, in order to achieve the purpose of the anti-reflection, a second thickness of the second anti-reflection film 50 may be adjusted based on a second refractive index of the second anti-reflection film 50 and a transmission spectrum of a second light 102 penetrating the liquid crystal display device 10, so that destructive interference occurs between lights reflected by upper and lower interfaces of the second anti-reflection film 50.

In order to achieve a better anti-reflection effect, a preferred second thickness e_{z} of the second anti-reflection film 50 may be calculated by the following formula (II).

$${e}_{2} = \frac{{λ}_{2}}{4 \times {n}_{2}} \qquad Formula ( II )$$

e₂ is the second thickness of the second anti-reflection film 50, λ₂ is a second wavelength of the second light 102, and n₂ is the second refractive index of the second anti-reflection film 50.

As mentioned above, generally, refractive indexes of glass substrates and polarizers are about 1.52, and a refractive index of air is 1. Therefore, the second refractive index of the second anti-reflection film 50 is preferably 1.23 to 1.38, but is not limited thereto. The second reflectivity may be adjusted by changing a material of the second anti-reflection film 50. The second wavelength may be a wavelength of the second light 102 mainly passing through the liquid crystal display device 10. That is, the anti-reflection is performed on a wavelength of the brightness mainly generated by the liquid crystal display device 10. According to transmission spectrums of commonly used liquid crystal display devices, reducing a reflection of green light with a wavelength of 540 nm to 560 nm can significantly improve a transmittance. Therefore, the second wavelength of the second light 102 may be 540 nm to 560 nm, but is not limited thereto. The second wavelength may be adjusted by changing a transmission spectrum of the liquid crystal display device 10. When the second refractive index is 1.23 to 1.38, and the second wavelength of the second light 102 is 540 nm to 560 nm, the second thickness of the second anti-reflection film 50 is preferably 97.8 nm to 113.8 nm, but is not limited thereto.

For example, when the second wavelength κ_{z} is 540 nm, if the second refractive index n₂ is set to 1.23, the second thickness e₂ is preferably 109.8 nm; and if the second refractive index n₂ is set to 1.38, the second thickness e₂ is preferably 97.8 nm. When the second wavelength λ₂ is 560 nm, if the second refractive index n₂ is set to 1.23, the second thickness e₂ is preferably 113.8 nm; and if the second refractive index n₂ is set to 1.38, the second thickness e₂ is preferably 101.4 nm.

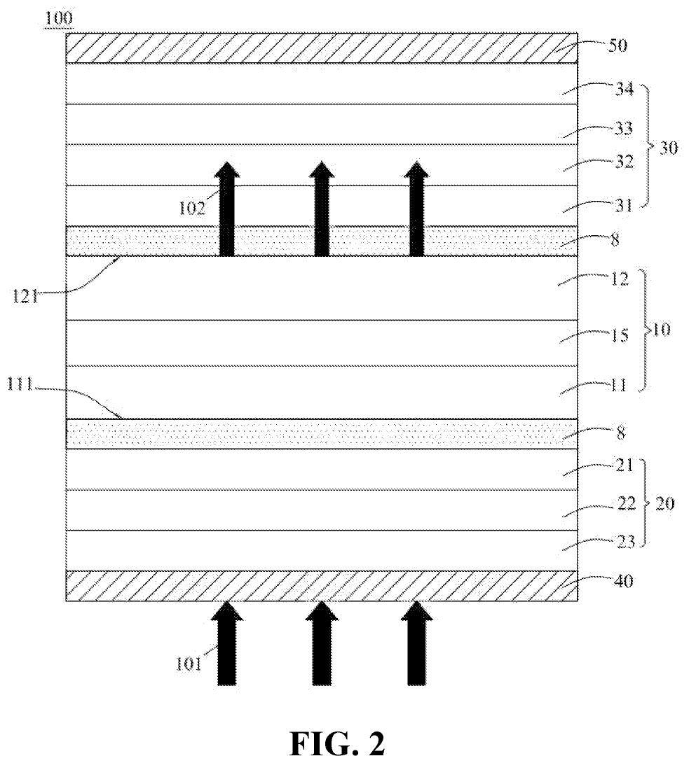

In a first embodiment, please refer to FIG. 2, the first polarizer 20 comprises an optical compensation film 21, a polarizing layer 22, and a protective layer 23 in sequence. The second polarizer 30 comprises an optical compensation film 31, a polarizing layer 32, a protective layer 33, and a hardened layer 34 in sequence. The polarizing layers 22 and 32 have a polarization function. The polarizing layers 22 and 32 may be made of poly(vinyl alcohol) (PVA), but are not limited thereto. The optical compensation layers 21 and 31 are configured to compensate for light leakage and color shift of the liquid crystal display device 10. The protective layers 23 and 33 are configured to protect the polarizing layers 22 and 32, respectively. The protective layers 23 and 33 can prevent moisture from entering the first polarizer 20 and the second polarizer 30, respectively. The protective layers 23 and 33 may be made of tri-acetyl cellulose (TAC), but are not limited thereto. The hardened layer 34 is configured to prevent the second polarizer 30 from being scratched. In this embodiment, the protective layer 23 is disposed on a side of the first polarizer 20 furthest away from the liquid crystal display panel 10, and the first anti-reflection film 40 is directly formed on a surface of the protective layer 23 away from the liquid crystal display panel 10. Furthermore, the hardened layer 34 is disposed on a side of the second polarizer 30 furthest away from the liquid crystal display panel 10, and the second anti-reflection film 50 is directly formed on a surface of the hardened layer 34 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

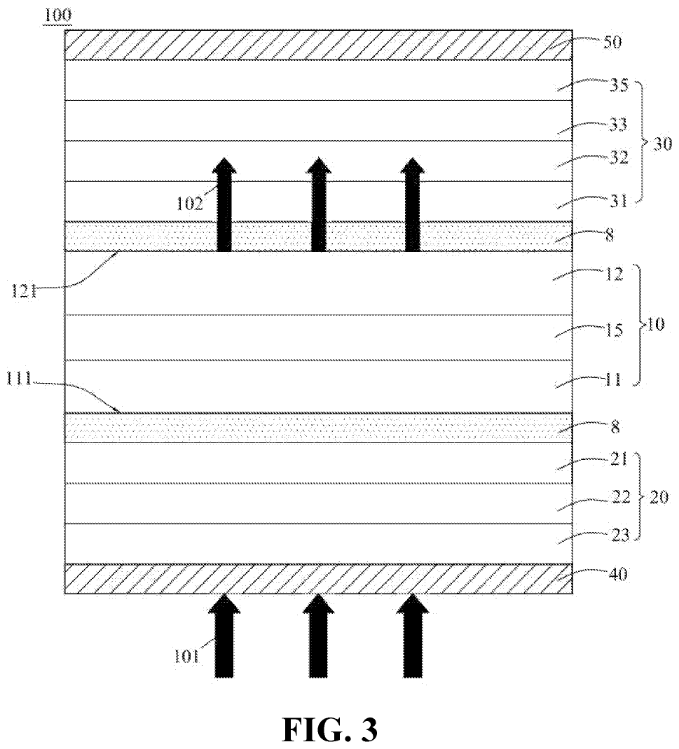

In a second embodiment, please refer to FIG. 3, the first polarizer 20 comprises the optical compensation film 21, the polarizing layer 22, and the protective layer 23 in sequence. The second polarizer 30 comprises the optical compensation film 31, the polarizing layer 32, the protective layer 33, and an anti-glare coating 35 in sequence. The second embodiment is different from the first embodiment in that the second embodiment replaces the hardened layer 34 in the second polarizer 30 of the first embodiment with the anti-glare coating 35. In this embodiment, the anti-glare coating 35 is disposed on the side of the second polarizer 30 furthest away from the liquid crystal display panel 10. The second anti-reflection film 50 is directly formed on a surface of the anti-glare coating 35 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

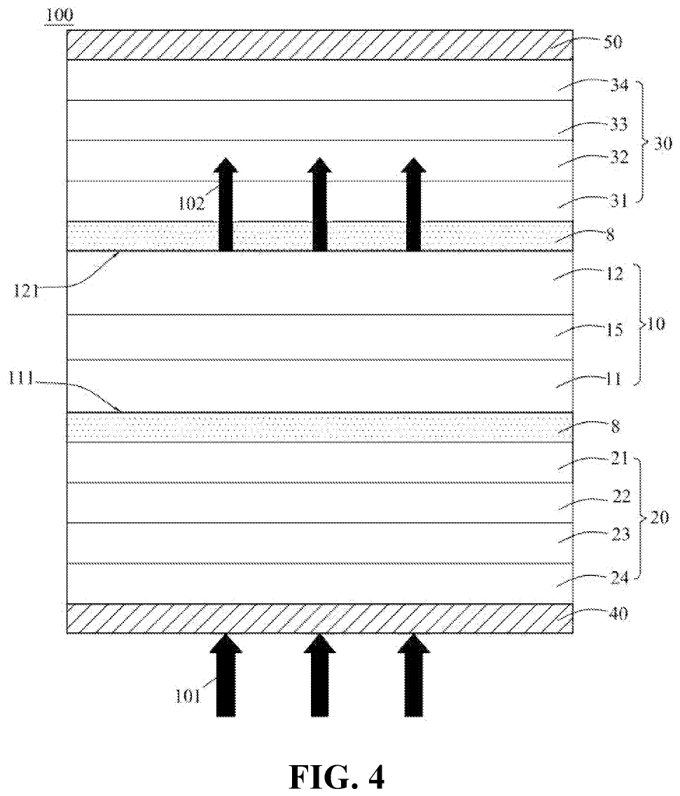

In a third embodiment, please refer to FIG. 4, the first polarizer 20 comprises the optical compensation film 21, the polarizing layer 22, the protective layer 23, and a hardened layer 24 in sequence. The second polarizer 30 comprises the optical compensation film 31, the polarizing layer 32, the protective layer 33, and the hardened layer 34 in sequence. The third embodiment is different from the first embodiment in that the first polarizer 20 of the third embodiment is additionally provided with the hardened layer 24. The hardened layer 24 is configured to prevent the first polarizer 20 from being scratched. In this embodiment, the hardened layer 24 is disposed on the side of the first polarizer 20 furthest away from the liquid crystal display panel 10, and the first anti-reflection film 40 is directly formed on a surface of the hardened layer 24 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

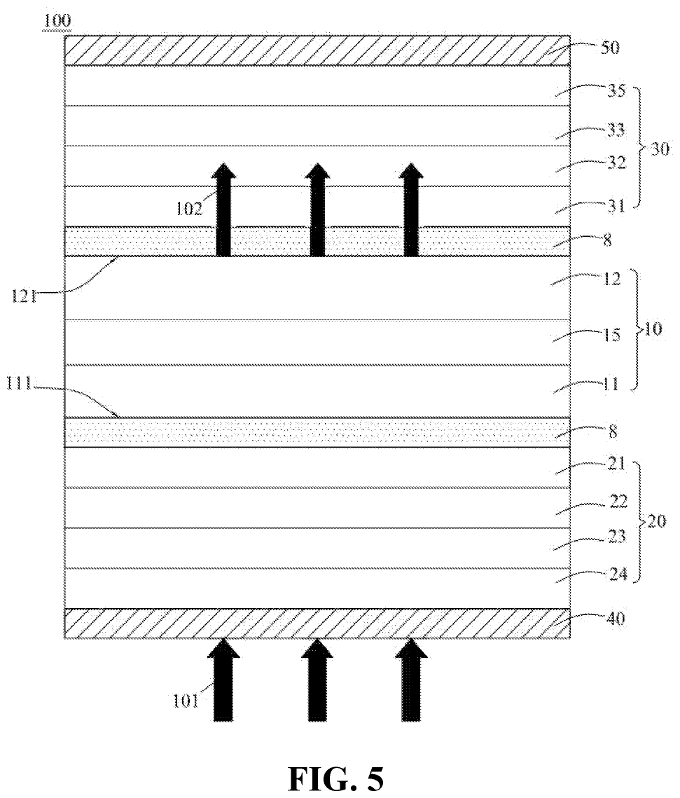

In a fourth embodiment, please refer to FIG. 5, the first polarizer 20 comprises the optical compensation film 21, the polarizing layer 22, the protective layer 23, and a hardened layer 24 in sequence. The second polarizer 30 comprises the optical compensation film 31, the polarizing layer 32, the protective layer 33, and an anti-glare coating 35 in sequence. The fourth embodiment is different from the second embodiment in that the first polarizer 20 of the fourth embodiment is additionally provided with the hardened layer 24. In this embodiment, the hardened layer 24 is disposed on the side of the first polarizer 20 furthest away from the liquid crystal display panel 10, and the first anti-reflection film 40 is directly formed on a surface of the hardened layer 24 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

Please refer to FIG. 1, the present disclosure further provides a liquid crystal display device 100 comprising a liquid crystal display panel 10, a first polarizer 20, a second polarizer 30, a first anti-reflection film 40, and a second anti-reflection film 50. The liquid crystal display panel 10 comprises a light-incident surface 111 and a light-emitting surface 121 on opposite sides thereof. Specifically, the liquid crystal display panel 10 comprises an array substrate 11, a color filter substrate 12, and a liquid crystal layer 15. The array substrate 11 and the color filter substrate 12 are disposed oppositely. The liquid crystal layer 15 is disposed between the array substrate 11 and the color filter substrate 12. The light-incident surface 111 of the liquid crystal display panel 10 is a surface of the array substrate 11 away from the liquid crystal layer 15. The light-emitting surface 121 of the liquid crystal display panel 10 is a surface of the color filter substrate 12 away from the liquid crystal layer 15. The first polarizer 20 is disposed on the light-incident surface 111 of the liquid crystal display panel 10. The first anti-reflection film 40 is directly formed on a surface of the first polarizer 20 away from the liquid crystal display panel 10. The second polarizer 30 is disposed on the light-emitting surface 121 of the liquid crystal display panel 10. The second anti-reflection film 50 is directly formed on a surface of the second polarizer 30 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50. In an embodiment, positions of the first polarizer 20 and the second polarizer 30 can be interchanged. The first anti-reflection film 40 and the second anti-reflection film 50 may be formed of a material with a low refractive index and high strength, such as magnesium fluoride. The first anti-reflection film 40 and the second anti-reflection film 50 may be formed of a same material or different materials.

In an embodiment, the liquid crystal display device 100 further comprises two adhesive layers 8. The adhesive layers 8 are disposed between the first polarizer 20 and the light-incident surface 111, and between the second polarizer 30 and the light-emitting surface 121. The adhesive layers 8 are configured to adhere the first polarizer 20 to the light-incident surface 111, and adhere the second polarizer 30 to the light-emitting surface 121. The adhesive layers 8 may be made of a pressure-sensitive adhesive. The pressure-sensitive adhesive may be a polypropylene-based adhesive, but is not limited thereto.

In order to achieve a purpose of anti-reflection, a first thickness of the first anti-reflection film 40 may be adjusted based on a first refractive index of the first anti-reflection film 40 and a spectrum of a first light 101 emitted by a backlight panel, so that destructive interference occurs between lights reflected by upper and lower interfaces of the first anti-reflection film 40. Similarly, a second thickness of the second anti-reflection film 50 may be adjusted based on a second refractive index of the second anti-reflection film 50 and a transmission spectrum of a second light 102 penetrating the liquid crystal display device 10, so that destructive interference occurs between lights reflected by upper and lower interfaces of the second anti-reflection film 50. For calculation of preferred thicknesses of the first anti-reflection film 40 and the second anti-reflection film 50, please refer to the above content, and will not be described in detail herein.

In a first embodiment, please refer to FIG. 2, the first polarizer 20 comprises an optical compensation film 21, a polarizing layer 22, and a protective layer 23 in sequence. The second polarizer 30 comprises an optical compensation film 31, a polarizing layer 32, a protective layer 33, and a hardened layer 34 in sequence. The polarizing layers 22 and 32 have a polarization function. The polarizing layers 22 and 32 may be made of poly(vinyl alcohol), but are not limited thereto. The optical compensation layers 21 and 31 are configured to compensate for light leakage and color shift of the liquid crystal display device 10. The protective layers 23 and 33 are configured to protect the polarizing layers 22 and 32, respectively. The protective layers 23 and 33 can prevent moisture from entering the first polarizer 20 and the second polarizer 30, respectively. The protective layers 23 and 33 may be made of tri-acetyl cellulose, but are not limited thereto. The hardened layer 34 is configured to prevent the second polarizer 30 from being scratched. In this embodiment, the protective layer 23 is disposed on a side of the first polarizer 20 furthest away from the liquid crystal display panel 10, and the first anti-reflection film 40 is directly formed on a surface of the protective layer 23 away from the liquid crystal display panel 10. Furthermore, the hardened layer 34 is disposed on a side of the second polarizer 30 furthest away from the liquid crystal display panel 10, and the second anti-reflection film 50 is directly formed on a surface of the hardened layer 34 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

In a second embodiment, please refer to FIG. 3, the first polarizer 20 comprises the optical compensation film 21, the polarizing layer 22, and the protective layer 23 in sequence. The second polarizer 30 comprises the optical compensation film 31, the polarizing layer 32, the protective layer 33, and an anti-glare coating 35 in sequence. The second embodiment is different from the first embodiment in that the second embodiment replaces the hardened layer 34 in the second polarizer 30 of the first embodiment with the anti-glare coating 35. In this embodiment, the anti-glare coating 35 is disposed on the side of the second polarizer 30 furthest away from the liquid crystal display panel 10. The second anti-reflection film 50 is directly formed on a surface of the anti-glare coating 35 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

In a third embodiment, please refer to FIG. 4, the first polarizer 20 comprises the optical compensation film 21, the polarizing layer 22, the protective layer 23, and a hardened layer 24 in sequence. The second polarizer 30 comprises the optical compensation film 31, the polarizing layer 32, the protective layer 33, and the hardened layer 34 in sequence. The third embodiment is different from the first embodiment in that the first polarizer 20 of the third embodiment is additionally provided with the hardened layer 24. The hardened layer 24 is configured to prevent the first polarizer 20 from being scratched. In this embodiment, the hardened layer 24 is disposed on the side of the first polarizer 20 furthest away from the liquid crystal display panel 10, and the first anti-reflection film 40 is directly formed on a surface of the hardened layer 24 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

In a fourth embodiment, please refer to FIG. 5, the first polarizer 20 comprises the optical compensation film 21, the polarizing layer 22, the protective layer 23, and a hardened layer 24 in sequence. The second polarizer 30 comprises the optical compensation film 31, the polarizing layer 32, the protective layer 33, and an anti-glare coating 35 in sequence. The fourth embodiment is different from the second embodiment in that the first polarizer 20 of the fourth embodiment is additionally provided with the hardened layer 24. In this embodiment, the hardened layer 24 is disposed on the side of the first polarizer 20 furthest away from the liquid crystal display panel 10, and the first anti-reflection film 40 is directly formed on a surface of the hardened layer 24 away from the liquid crystal display panel 10. In an embodiment, the liquid crystal display panel 10 may only be provided with the first polarizer 20 and the first anti-reflection film 40. In an embodiment, the liquid crystal display panel 10 may only be provided with the second polarizer 30 and the second anti-reflection film 50.

In the above, in the liquid crystal display device and the method for fabricating the same provided by the present disclosure, the first anti-reflection film is directly formed on the first polarizer, and/or the second anti-reflection film is directly formed on the second polarizer. In this way, without changing a manufacturing process and a structure of the liquid crystal panel and an overall thickness of the liquid crystal display device, a reflectivity of the liquid crystal display device can be reduced, thereby improving a transmittance of the liquid crystal display device.

The liquid crystal display device and the method for fabricating the same provided by the embodiments of the present disclosure are described in detail above. The above description of the embodiments is only for helping to understand the technical solutions of the present disclosure and its core ideas, and is not intended to limit the claimed scope of the present application. It should be understood that those skilled in the art can modify or replace the technical solutions described in the above embodiments. Any modification or replacement within the core ideas of the technical solutions of the present disclosure is within the claimed scope of the present application.

1. A method for fabricating a liquid crystal display device, comprising:
providing a liquid crystal display panel, wherein the liquid crystal display panel comprises a light-incident surface and a light-emitting surface on opposite sides thereof;
disposing a first polarizer on the light-incident surface or the light-emitting surface of the liquid crystal display panel; and
directly forming a first anti-reflection film on a surface of the first polarizer away from the liquid crystal display panel.

2. The method according to claim 1, further comprising:
disposing a second polarizer on a surface of the liquid crystal display panel away from the first polarizer; and
directly forming a second anti-reflection film on a surface of the second polarizer away from the liquid crystal display panel.

3. The method according to claim 1, wherein
the first polarizer is disposed on the light-incident surface of the liquid crystal display panel;
the first polarizer comprises a protective layer disposed on a side of the first polarizer furthest away from the liquid crystal display panel to prevent moisture from entering the first polarizer; and
the first anti-reflection film is directly formed on a surface of the protective layer of the first polarizer away from the liquid crystal display panel.

4. The method according to claim 3, further comprising:
disposing a second polarizer on the light-emitting surface of the liquid crystal display panel, wherein the second polarizer comprises a hardened layer disposed on a side of the second polarizer furthest away from the liquid crystal display panel to prevent the second polarizer from being scratched; and
directly forming a second anti-reflection film on a surface of the hardened layer of the second polarizer away from the liquid crystal display panel.

5. The method according to claim 3, further comprising:
disposing a second polarizer on the light-emitting surface of the liquid crystal display panel, wherein the second polarizer comprises an anti-glare coating disposed on a side of the second polarizer furthest away from the liquid crystal display panel; and
directly forming a second anti-reflection film on a surface of the anti-glare coating of the second polarizer away from the liquid crystal display panel.

6. The method according to claim 1, wherein
the first polarizer comprises a hardened layer disposed on a side of the first polarizer furthest away from the liquid crystal display panel to prevent the first polarizer from being scratched; and
the first anti-reflection film is directly formed on a surface of the hardened layer of the first polarizer away from the liquid crystal display panel.

7. The method according to claim 6, wherein the first polarizer is disposed on the light-incident surface of the liquid crystal display panel, and the method further comprises:
disposing a second polarizer on the light-emitting surface of the liquid crystal display panel, wherein the second polarizer comprises a hardened layer disposed on a side of the second polarizer furthest away from the liquid crystal display panel to prevent the second polarizer from being scratched; and
directly forming a second anti-reflection film on a surface of the hardened layer of the second polarizer away from the liquid crystal display panel.

8. The method according to claim 6, wherein the first polarizer is disposed on the light-incident surface of the liquid crystal display panel, and the method further comprises:
disposing a second polarizer on the light-emitting surface of the liquid crystal display panel, wherein the second polarizer comprises an anti-glare coating disposed on a side of the second polarizer furthest away from the liquid crystal display panel; and
directly forming a second anti-reflection film on a surface of the anti-glare coating of the second polarizer away from the liquid crystal display panel.

9. The method according to claim 1, wherein
the first polarizer is disposed on the light-emitting surface of the liquid crystal display panel;
the first polarizer comprises an anti-glare coating disposed on a side of the first polarizer furthest away from the liquid crystal display panel; and
the first anti-reflection film is directly formed on a surface of the anti-glare coating of the first polarizer away from the liquid crystal display panel.

10. The method according to claim 1, wherein the liquid crystal display panel comprises an array substrate, a color filter substrate, and a liquid crystal layer disposed between the array substrate and the color filter substrate, the light-incident surface of the liquid crystal display panel is a surface of the array substrate away from the liquid crystal layer, and the light-emitting surface of the liquid crystal display panel is a surface of the color filter substrate away from the liquid crystal layer.

11. A liquid crystal display device, comprising:
a liquid crystal display panel comprising a light-incident surface and a light-emitting surface on opposite sides thereof;
a first polarizer disposed on the light-incident surface or the light-emitting surface of the liquid crystal display panel; and
a first anti-reflection film directly formed on a surface of the first polarizer away from the liquid crystal display panel.

12. The liquid crystal display device according to claim 11, further comprising:
a second polarizer disposed on a surface of the liquid crystal display panel away from the first polarizer; and
a second anti-reflection film directly formed on a surface of the second polarizer away from the liquid crystal display panel.

13. The liquid crystal display device according to claim 11, wherein
the first polarizer is disposed on the light-incident surface of the liquid crystal display panel;
the first polarizer comprises a protective layer disposed on a side of the first polarizer furthest away from the liquid crystal display panel to prevent moisture from entering the first polarizer; and
the first anti-reflection film is directly formed on a surface of the protective layer of the first polarizer away from the liquid crystal display panel.

14. The liquid crystal display device according to claim 13, further comprising:
a second polarizer disposed on the light-emitting surface of the liquid crystal display panel and comprising a hardened layer, wherein the hardened layer is disposed on a side of the second polarizer furthest away from the liquid crystal display panel to prevent the second polarizer from being scratched; and
a second anti-reflection film directly formed on a surface of the hardened layer of the second polarizer away from the liquid crystal display panel.

15. The liquid crystal display device according to claim 13, further comprising:
a second polarizer disposed on the light-emitting surface of the liquid crystal display panel and comprising an anti-glare coating, wherein the anti-glare coating is disposed on a side of the second polarizer furthest away from the liquid crystal display panel; and
a second anti-reflection film directly formed on a surface of the anti-glare coating of the second polarizer away from the liquid crystal display panel.

16. The liquid crystal display device according to claim 11, wherein
the first polarizer comprises a hardened layer disposed on a side of the first polarizer furthest away from the liquid crystal display panel to prevent the first polarizer from being scratched; and
the first anti-reflection film is directly formed on a surface of the hardened layer of the first polarizer away from the liquid crystal display panel.

17. The liquid crystal display device according to claim 16, wherein
the first polarizer is disposed on the light-incident surface of the liquid crystal display panel, and the liquid crystal display device further comprises:
a second polarizer disposed on the light-emitting surface of the liquid crystal display panel and comprising a hardened layer, wherein the hardened layer is disposed on a side of the second polarizer furthest away from the liquid crystal display panel to prevent the second polarizer from being scratched; and
a second anti-reflection film directly formed on a surface of the hardened layer of the second polarizer away from the liquid crystal display panel.

18. The liquid crystal display device according to claim 16, wherein
the first polarizer is disposed on the light-incident surface of the liquid crystal display panel, and the liquid crystal display device further comprises:
a second polarizer disposed on the light-emitting surface of the liquid crystal display panel and comprising an anti-glare coating, wherein the anti-glare coating is disposed on a side of the second polarizer furthest away from the liquid crystal display panel; and
a second anti-reflection film directly formed on a surface of the anti-glare coating of the second polarizer away from the liquid crystal display panel.

19. The liquid crystal display device according to claim 11, wherein
the first polarizer is disposed on the light-emitting surface of the liquid crystal display panel;
the first polarizer comprises an anti-glare coating disposed on a side of the first polarizer furthest away from the liquid crystal display panel; and
the first anti-reflection film is directly formed on a surface of the anti-glare coating of the first polarizer away from the liquid crystal display panel.

20. The liquid crystal display device according to claim 11, wherein the liquid crystal display panel comprises an array substrate, a color filter substrate, and a liquid crystal layer disposed between the array substrate and the color filter substrate, the light-incident surface of the liquid crystal display panel is a surface of the array substrate away from the liquid crystal layer, and the light-emitting surface of the liquid crystal display panel is a surface of the color filter substrate away from the liquid crystal layer.
